(19) United States
(12) Patent Application Publication
(10) Pub. No.: US 2005/0226553 A1
(43) Pub. Date: Oct. 13, 2005

(54) Optical filtration device

(75) Inventors: Xavier Hugon, Coublevie (FR); Jean-Pierre Moy, Saint Egreve (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: ATMEL GRENOBLE S.A., Saint Egreve (FR)

(21) Appl. No.: 10/516,461

(22) PCT Filed: Jun. 2, 2003
(86) PCT No.: PCT/FR03/01653

§ 371 Date: Dec. 3, 2004

(30) Foreign Application Priority Data
Jun. 4, 2002 (FR) 02/06853

(51) Int. Cl. G02B 6/28

(52) U.S. Cl. 385/24

(57) ABSTRACT

The invention relates to wavelength selective optical components for transmitting the light in a narrow spectral band, which is centered around a wavelength, and for reflecting the wavelengths lying outside this band. The component includes an input guide (2) conducting light radiation (3) to a tunable filter (1), an input guide (2) conducting the radiation (3) to the filter (1) in order to perform a first pass through it. The component includes means (6) for returning a first part (4) of the radiation (3) reflected by the filter (1) during the first pass in order to perform a second pass through it.

The invention relates to wavelength selective optical components for transmitting the light in a narrow spectral band, which is centered around a wavelength, and for reflecting the wavelengths lying outside this band. Adjustment of the central wavelength of the narrow spectral band by electrical means may be provided.

The word “light” is intended in the wide sense and includes, in particular, spectral bands in the infrared as will be seen below, a major application of the invention being to filter light in the various fiber optic telecommunication bands lying between 1.3 and 1.61 micrometers.

The advantage of these 1.3 to 1.61 micrometer bands results from the fact that current optical fibers, made of glass, have low attenuation and the optical signals can therefore be transmitted over very large distances. In what follows, the invention will be explained with reference to this spectral band, although it should be understood that the invention may be applied to other bands if the need arises, by using materials suitable for these different bands.

In a fiber optic telecommunication network, a cable comprising a plurality of optical fibers can be used to produce a plurality of different transmission channels; time division multiplexing of the information may also be carried out in order to achieve the same objective; with a view to further increasing the information delivery capacity of the network, however, the current trend is for a plurality of light wavelengths, modulated independently of one another and each defining an information channel, to be transmitted simultaneously on the same optical fiber. ITU (International Telecommunications Union) Standard 692 proposes the definition of adjacent channels with an optical spectral bandwidth of 100 GHz, centered on N adjacent standardized optical frequencies whose values are 200 terahertz, 199.9 terahertz, 199.8 terahertz, etc., corresponding to N wavelengths of from 1.52 micrometers to 1.61 micrometers. Modulation of the light at from 10 to 40 gigabits per second can be carried out on a channel having this bandwidth, without too much risk of interference between the immediately adjacent spectral bands (by using modulation pulses of Gaussian shape in order to minimize the passband occupied by this modulation). This technique of frequency division multiplexing is referred to as DWDM, standing for “Dense Wavelength Division Multiplexing”.

In a telecommunication network, the problem is therefore that of being able to collect the light corresponding to a determined channel without perturbing the light of the neighboring channels. At a transmission node of the network, which is assigned to the transmission and reception of information on channel i, for example, it is necessary to be able to collect the light with a central frequency Fᵢ (wavelength λᵢ) without impeding transmission of the light modulating the central frequencies F₁ to F_{N}, even though these optical frequencies are very close together.

To that end, there is a need to produce optical filtering components which are highly selective for light wavelengths and are capable of transmitting the central optical frequency Fᵢ and the frequencies lying in a narrow band of less than 50 GHz on either side of this frequency, and of blocking the other bands. Only the light of channel i is collected at the output of such a filter, and this can be demodulated in order to collect the useful information or send it into another branch of the network.

It has already been proposed to produce filtering components that operate on the principle of Fabry-Perot interferometers, which are produced by depositing semiconductor layers separated from one another by air gaps with thicknesses calibrated according to the wavelength λᵢ to be selected. In practice, an interferometer comprises two mirrors made of stacked dielectric layers (Bragg mirrors) with a high coefficient of reflection, which are separated by a transparent zone with an optical thickness of k·λᵢ/2 (real thickness k·λᵢ/2 if the zone is an air gap), where k is an integer defining the order of the interferometric filter. Indium phosphide (InP) is highly suitable for these embodiments, in particular because of its transparency for the wavelengths in question, its very high refractive index and the possibility of depositing epitaxial layers with a well controlled thickness.

If the thicknesses of the layers and the intervals between layers are very well controlled, and if the materials have a high refractive index, such a filter turns out to be highly selective.

Such an embodiment is described in the article by A. Spisser et al., “Highly Selective 1.55 micrometer InP/airgap micromachined Fabry-Perot filter for optical communications” in Electronics Letters, No 34 (5), pages 453-454, 1998. Other embodiments, made of micromachined silicon and of alloys based on gallium arsenide, have been proposed.

Owing to the imperfections in the production of the filtering components and owing to the spectral width due to the modulation of the signal, a fraction of the light around the central wavelength is reflected by the filtering component, which is acceptable only if this fraction is less than about 1% of the signal because this would be a cause of interference for the reflected signal, in particular when replacement radiation modulated substantially around the same central wavelength is added to the radiation reflected by the component. In order to satisfy this requirement with fixed filtering components, it is possible to use two filters arranged so that the radiation reflected by the first filter is reflected again at the second filter.

This arrangement eliminates the residues of light radiation centered around the central wavelength in the output channel of the component, and does not pose any great optical problems because these filtering components are wide and therefore operate with low aperture beams, for which the large Rayleigh length permits folding of the path.

The central wavelengths of the channels are defined by standards (ITU 692 for Dense Wavelength Division Multiplexing). In the “Dense Wavelength Division Multiplexing” case, when the channels are separated by scarcely more than their spectral width, each light source such as a laser which forms a channel is necessarily locked onto an ITU frequency to within a few GHz, by using an external source. For short distance communications with a small number of channels, another concept is often used in which the channels are much more spaced, for example by 20 nm (=2500 GHz). The latter concept is also defined by the ITU 692 standard with the name “Coarse Wavelength Division Multiplexing”. The spacing is then significantly more than the drifts and thermal fluctuations or the like, for example of the emission frequency of the laser. These drifts are of the order of a few hundreds of GHz. It is then possible to use lasers which are much less expensive, because their need for frequency slaving is obviated. There is of course no correlation between the wavelength which is extracted and that of the replacement radiation. Using a tunable narrowband filter with tracking of the incident wavelength, it is possible to extract radiation with a given central wavelength but it is not possible to inject replacement radiation into a channel left vacant, because the filter is not generally transparent for the replacement radiation. The principle described above is therefore difficult to implement, because the second filter tunable to the wavelength of the replacement radiation will not reject the residues of the light radiation centered around the central wavelength of the extracted radiation.

The problem is therefore that of finding a configuration which makes it possible to use a narrowband tunable filter with wavelength tracking in a multiplexer, while offering good rejection of the extracted wavelength and good injection of the replacement wavelength.

It is an object of the invention to resolve this problem by providing an optical filtering component which produces a double pass through the same tunable filter. More precisely, the invention relates to an optical filtering component including a tunable and wavelength selective filter capable of transmitting the light in a narrow optical spectral band centered around a given wavelength and capable of reflecting the light whose wavelength is outside said band, an input guide conducting light radiation to the filter, characterized in that the input guide conducts the radiation to the filter in order to perform a first pass through it, and in that the component includes means for returning a first part of the radiation reflected by the filter during the first pass in order to perform a second pass through it.

Tunable filters generally have dimensions much smaller than those of fixed filters which are centered by design around a given wavelength.

For fixed filters, that is to say ones which are centered by design around a given wavelength, a double pass is produced by using one waveguide for each input and one waveguide for each output of the filter. The direct implementation of such an embodiment with a tunable filter poses enormous problems of positioning each waveguide in space. The invention also resolves this problem by limiting the number of components to be positioned with respect to one another.

It will be noted that the first part of the radiation is the majority of the radiation. More precisely the radiation includes a plurality of channels, each centered around a wavelength. The filter makes it possible to extract one of the channels and reflect the others. These other channels form the first part of the radiation.

Advantageously, the component includes means for tuning the given wavelength. In other words, the invention has a particular advantage in the event that the filter is tunable.

The invention will be understood more clearly and other advantages will become apparent on reading the detailed description of an embodiment of the invention which is given by way of example, the description being illustrated by the appended drawing in which:

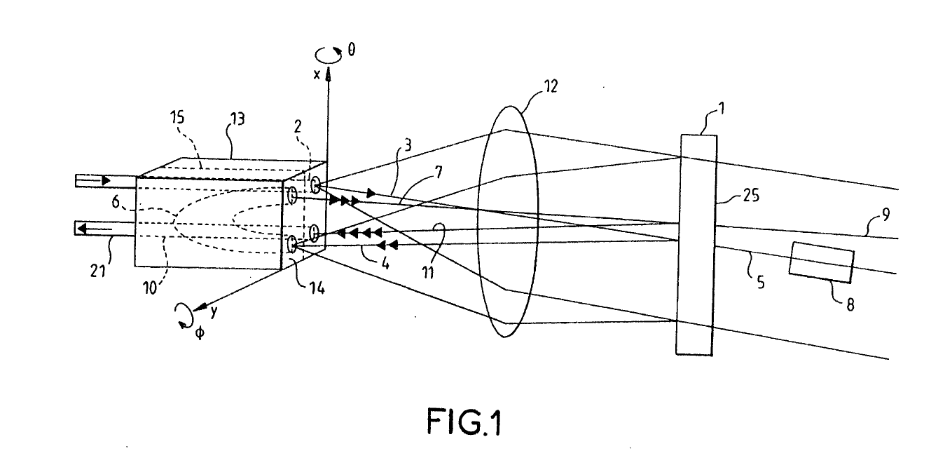

FIG. 1 represents an example of an optical path through an optical filtering component according to the invention;

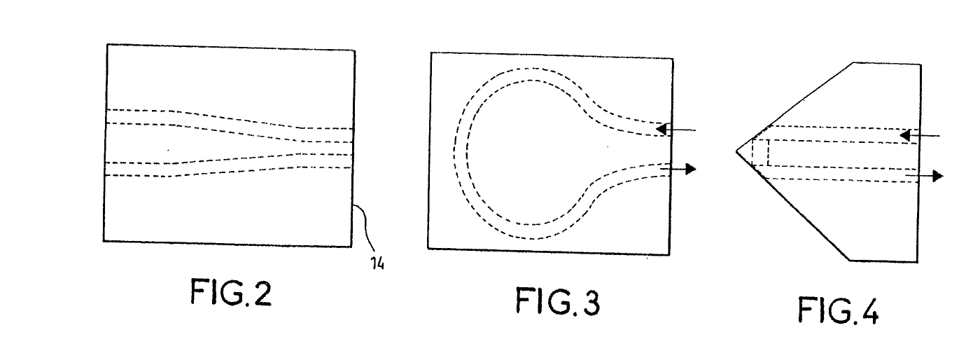

FIGS. 2, 3 and 4 represent examples of waveguides for producing the return means;

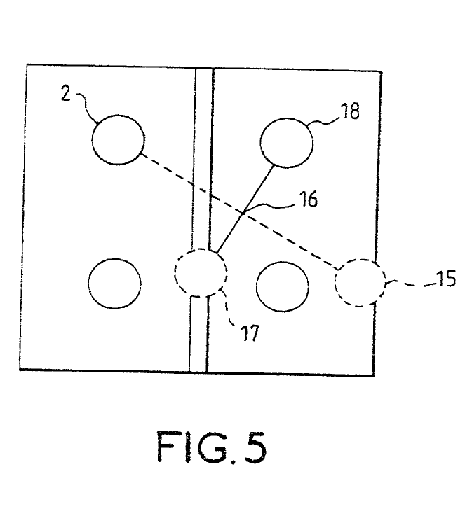

FIG. 5 illustrates the alignment of the return means with the filter;

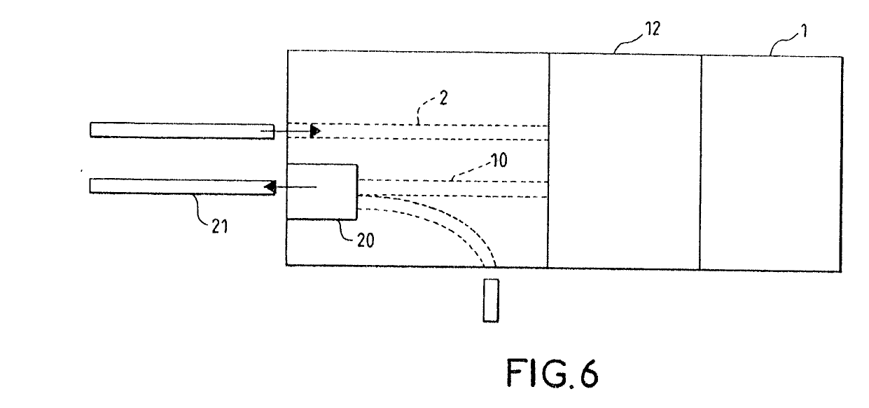

FIG. 6 illustrates the injection of replacement radiation at the output of the optical filtering component.

The optical filtering component represented in FIG. 1 includes a wavelength selective filter 1 capable of transmitting the light in a narrow optical spectral band and reflecting the light whose wavelength is outside this band. The filter 1 is, for example, produced according to the article by A. Spisser cited above. The optical component furthermore includes an input guide 2 conducting light radiation 3 to the filter 1 in order to perform a first pass through it. After this first pass, a first part 4 of the radiation 3 is reflected by the filter 1 while a second part 5 of the radiation 3 is transmitted through the filter 1, according to the selectivity of the filter 1. The component furthermore includes return means 6. These means 6 collect the first part 4 of the radiation 3 so as to return it to the filter 1 in order to perform a second pass through it. At the output of the return means 6, the path of the first part 4 of the radiation 3 is constituted by the segment 7.

The optical filtering component includes a first output guide and associated focusing means, which conduct the second part 5 of the radiation 3. A third part 9 of the radiation 3 is transmitted by the filter 1 during the second pass. This third part 9 constitutes an eliminated residue of the first part 4 of the radiation 3. The optical filtering component also includes a second output guide 10 conducting the fourth part 11 of the radiation 3, which part 11 is reflected by the filter 1 during the second pass through the filter 1. The fourth part 11 of the radiation 3 is formed by the first part 4 less the third part 9 which has been removed.

Advantageously, the return means 6 direct the first part 4 of the radiation 3 to the filter 1, with the same incidence as the input guide.

The central wavelength of the optical spectral band transmitted by the filter 1 depends on the orientation or incidence with which radiation enters the filter 1. In other words, equality of the incidences makes it possible for the filter to keep the same transfer function for both passes through the filter. The advantage provided by equal incidence of the radiation 3 and of its fourth part 4 during its transit 7 will therefore be understood.

Of course, the equality of the incidences applies only to within the manufacturing tolerances. The equality of the incidences during the two passes should be precise if a narrow transmission peak of the filter 1 is desired. For example, if there is a width at half-height of 0.5 nm for the transmission peak, then a maximum shift of 0.1 nm between the two passes is tolerable. This corresponds to an incidence variation of a few milliradians for incidences in the vicinity of incidence perpendicular to the filter 1.

In order for the radiation incident on the filter to be reasonably collimated, the component advantageously includes collimation means common to the input guide 2, to the return means 6 and to the second output guide 10. More precisely, the component includes a lens 12 arranged between, on the one hand, the filter 1 and, on the other hand, the input guide 2, the return means 6 and the second output guide 10.

With a short focal lens 12 (focal length of the order of one millimeter) such as that used in components for optical fibers, it is not feasible to place the optical fibers in a plane, for example the focal plane of the lens 12, while complying with the incidence identity described above because the diameter of the fibers is too great. It might be conceivable to strip the fibers to the core, but this makes them extremely delicate to handle. The subject matter of the embodiment described below makes it possible to overcome this problem by using all three dimensions.

It is known to produce waveguides for wavelengths of the order of 1500 nm, which are highly suitable for optical fibers, by means for glass plate photolithography which ensure a positioning accuracy much better than 1 μm and ion exchange in order to locally modify the refractive index. In particular, it is known to produce two parallel guides buried to a depth of about 10 μm and separated from one another by a few tens of microns, as illustrated in FIG. 2. It is also known to produce curves with a radius of about 5 mm, as illustrated in FIG. 3, which makes it possible to produce a beam return. Such a return may also be produced by polishing two faces at 45° and total reflection (dihedron) as shown in FIG. 4.

By assembling a plate as described in FIG. 2 and a plate as described in FIG. 3 while superimposing the waveguides, it is possible to produce the return means 6. The same result can be obtained by assembling a plate as described in FIG. 2 and a plate as described in FIG. 4. It is then necessary to position the input and output ends of the guides of the return means 6 accurately in the focal plane of the lens 12.

The return means 6, the input guide 2 and the second output guide 10 are advantageously immobilized with respect to one another so as to form a block 13 which has a face 14 opposing the filter 1. The lens 12 is located between the face 14 and the filter 1. The block 13 is assembled, for example, by adhesively bonding glass plates in which waveguides have been produced. The adhesive bonding is carried out in a plane 15 perpendicular to the face 14. The waveguides are produced at a few tens of microns from the plane 15, which allows good isolation of the guides from one another. This isolation can be improved if an opaque layer, for example a layer of metal or filled resin, is deposited on one face of a glass plate, namely the face forming the plane 15, before adhesive bonding.

The lens 12 is advantageously a graded-index lens, widely known by the term GRIN lens. This type of lens presents the advantage of having two plane faces. Advantageously, a lens 12 may be selected such that its object focal plane coincides with an input face of the lens 12. This makes it possible to position the lens 12 on the face 14 of the block 13, for example by using a microscope to observe the face 14 through the lens 12.

The positioning of the lens 12 is intricate, and may be carried out in the following way:

The lens 12 (of the GRIN type or the like) is first positioned in translation along axes x and y contained in the plane of the face 14, then immobilized by mechanical means with respect to the block 13 containing the guides, while taking as a reference those faces of the block 13 which are by design located accurately with respect to the guides. This positioning is possible with a tolerance better than about ten microns. In the same way, before the immobilization of the lens 12, it is possible to position a capillary in which the lens 12 can slide in order to position it in translation along an axis z perpendicular to the axes x and y.

A light beam is subsequently injected through the input face 2, and the filter 1 is positioned approximately in translation along the axes x and y on the collimated beam while observing a rear face 25 of the filter 1 by optical means, for example by means of an infrared camera. The rear face 25 of the filter is on the opposite side from the one which receives the radiation 3.

The orientation of the filter 1 in rotation about the axes x and y, respectively with the angles 0 and φ, is then obtained by active alignment according to the conventional algorithms, for example by using a spiral scan in order to seek and optimize the received signal. Specifically, the image 15 of the input guide 2 in the focal plane of the lens 12 after the first reflection at the filter 1 is symmetrical with the input guide 2 relative to the impact of the normal 16 to the filter 1 passing through the centre of the lens 12, as shown by FIG. 5. Likewise, the image 17 of the output 18 of the return means 6 which brings the fourth part 4 of the radiation 3 into the focal plane with a view to the second pass through the filter 1 is also symmetrical with the output 18 of the return means 6 relative to the impact of the normal 16 to the filter 1. This schematic shows that the alignment of the two passes through the filter 1 may be carried out as a single pass, since there is no additional degree of freedom.

When the optimum for the angles θ and φ is found, the signal maximum is sought along the x and y directions and the filter 1 is immobilized.

The optical filtering component advantageously includes means for inserting replacement radiation whose wavelength is substantially centered on the given wavelength of the extracted radiation into the second output guide 10. In other words, the component includes means for inserting replacement radiation into the channel vacated by the extracted radiation.

The insertion of replacement radiation with a wavelength close to the extracted wavelength (but necessarily decorrelated from it since the sources of extracted and replacement radiation are separated and since no control is exerted on their various drifts) requires a coupler 20 in the second output guide 10. The coupler 20 is easy to produce in the buried guide technology already used in the invention to produce the guides of the block 13, as described in FIG. 6. This technique is described on the Internet site “www.teamphotonics.com” on the “waveguide technology” page.

An output fiber 21 will then need to be positioned actively at the output of the coupler 20.

The technique of optical guides in glass also applies to glasses doped with rare earths, which make it possible to amplify the optical radiation when they are excited by a shorter wavelength coming from a pump laser. This technique is described in the article by D. Barbier published in 1998: “Net Gain of 27 dB with a 8.6 cm-long Er-Yb-doped glass-planar-amplifier”, which article is cited on the Internet site “www.teamphotonics.com” on the “technical articles” page.

The guides may be produced in glasses doped with rare earths in order to compensate for the insertion losses of the component without adding an extra optical component on the path. To that end, it is necessary to provide input optics on one of the sides of the component, which can transport a pump beam to the guides where the radiation is circulating, and to provide a common path of the appropriate length, of the order of 10 centimeters. In other words, the component includes means for amplifying the radiation reflected by the filter.

It should be noted that, in this case, an appropriate feedback strategy can make it possible to use the tuning means of the filter 1 in order to slave the pump power as well, and thus ensure a constant level of the extracted radiation.

1. An optical filtering component, comprising:
a tunable and wavelength selective filter capable of transmitting the light in a narrow optical spectral band centered around a given wavelength and capable of reflecting the light whose wavelength is outside said band;
an input guide conducting light radiation to the filters wherein the input guide conducts the radiation to the filter in order to perform a first pass through it; in that the component includes and means for returning a first part of the radiation reflected by the filter during the first pass in order to perform a second pass through it; and collimation means common to the input guide, to the return means and to the second output guide.

2. The optical filtering component as claimed in claim 1, comprising a second output guide conducting a fourth part of the radiation reflected by the filter during the second pass.

3. The optical filtering component as claimed in claim, wherein a lens arranged between, on the one hand, the filter and, on the other hand, the input guide, the return means and the second output guide.

4. The optical filtering component as claimed in claim 3, wherein the lens is a graded index lens.

5. The optical filtering component as claimed in claim 4, wherein the lens is such that itsobject focal plane coincides with an input face of the lens.

6. The optical filtering component as claimed in claim 1, wherein the return means direct the first part of the radiation to the filter, with the same incidence as the input guide.

7. The optical filtering component as claimed in claim 1, wherein it includes means for tuning the given wavelength.

8. The optical filtering component as claimed in claim 1, wherein it includes means for inserting replacement radiation whose length is substantially centered on the given wavelength.

9. The optical filtering component as claimed in claim 1, wherein the return means are produced by means for glass plate photolithography and ion exchange.

10. The optical filtering component as claimed in claim 1, wherein it includes means for amplifying the radiation reflected by the filter.

11. The optical filtering component as claimed in claim 2, wherein it includes a lens arranged between, on the one hand, the filter and, on the other hand, the input guide, the return means and the second output guide.

12. The optical filtering component as claimed in claim 3, wherein it includes a lens arranged between, on the one hand, the filter and, on the other hand, the input guide, the return means and the second output guide.

13. The optical filtering component as claimed in claim 2, wherein the return means direct the first part of the radiation to the filter, with the same incidence as the input guide.

14. The optical filtering component as claimed in claim 3, wherein the return means direct the first part of the radiation to the filter, with the same incidence as the input guide.

15. The optical filtering component as claimed in claim 2, wherein it includes means for tuning the given wavelength.

16. The optical filtering component as claimed in claim 3, wherein it includes means for tuning the given wavelength.

17. The optical filtering component as claimed in claim 4, wherein it includes means for tuning the given wavelength.

18. The optical filtering component as claimed in claim 2, wherein it includes means for inserting replacement radiation whose length is substantially centered on the given wavelength.

19. The optical filtering component as claimed in claim 3, wherein it includes means for inserting replacement radiation whose length is substantially centered on the given wavelength.

20. The optical filtering component as claimed in claim 2, wherein the return means are produced by means for glass plate photolithography and ion exchange.

21. The optical filtering component as claimed in claim 3, wherein the return means are produced by means for glass plate photolithography and ion exchange.

22. The optical filtering component as claimed in claim 2, wherein it includes means for amplifying the radiation reflected by the filter.

23. The optical filtering component as claimed in claim 3, wherein it includes means for amplifying the radiation reflected by the filter.
